(19) United States
(12) Patent Application Publication
(10) Pub. No.: US 2006/0277104 A1
(43) Pub. Date: Dec. 7, 2006

(54) Systems and methods for measuring the effectiveness of in-store display advertising

(76) Inventors: Gary L. Overhultz, River Forest, IL (US); Edward J. Franczek, Glencoe, IL (US); Robert N. Michelson, Glencoe, IL (US)

Correspondence Address: Joseph M. Sauer;Jones Day, North Point, 901 Lakeside Avenue, Cleveland, OH, 44114, US

(21) Appl. No.: 11/434,856

(22) Filed: May 16, 2006

Related U.S. Application Data
(60) Provisional application No. 60/681,861, filed on May 17, 2005.

(51) Int. Cl. G06Q 30/00; G07G 1/00

(52) U.S. Cl. 705/14; 705/10

(57) ABSTRACT

In accordance with the teachings described herein, systems and methods are provided for measuring the effectiveness of an advertising display. A radio frequency identification (RFID) tag may be associated with an advertising display in a retail environment. One or more receivers may be used to receive an RFID signal from the RFID tag. One or more processors may be used to receive the RFID signal from the receivers to determine a time period during which the advertising display is located within the retail environment. The one or more processors may also receive sales data from the retail environment relating to an amount of sales of one or more products associated with the advertising display over the time period that the advertising display is located within the retail environment. The one or more processors may compare the sales data with one or more sets of control data to measure the effectiveness of the advertising display.

### CROSS-REFERENCE TO RELATED APPLICATION

This application claims priority from U.S. Provisional Application No. 60/681,861, titled “System and Method of Prioritization of Effectiveness and Profitability of In-Store Display Advertising,” filed on May 17, 2005, which is incorporated herein by reference in its entirety.

### FIELD

The technology described in this patent document relates generally to radio frequency identification (RFID) systems. More particularly, systems and methods are provided for measuring on a real time basis the effectiveness of in-store display advertising. The results of in-store promotional sales of retail products may be monitored on a daily basis in order to determine, on a real-time basis, the effectiveness and profitability of the promotion.

### BACKGROUND

It is well known in the retail product industry to engage in promotional sales of any given product. In a promotional sale, the product manufacturer typically enters into an agreement with the retailer, usually a chain of retail stores, to promote a particular product. In many cases, the agreement may require the retailer to place in-store promotional advertising displays for a given product in specific locations within specific stores over a set period of time. In order to evaluate the results of the product promotion, physical audits are typically performed to determine whether the promotional displays were placed at the agreed upon locations within the store during the promotional time period, and if so placed, whether the promotion resulted in an increase in sales.

In many cases, however, the results of a physical audit are reported weeks after the promotion has concluded. In addition, the audit results are typically limited to a small number of stores (e.g., 5% of the stores in a chain), and it is therefore difficult to evaluate the effectiveness of a promotion across an entire chain of stores. Further, audit information is often incomplete, inaccurate, late in time and very expensive to gather. It is also difficult to know if all of the in-store promotional displays for any given store have been placed in the agreed upon location, or, if properly placed, when and how long they have been in such locations. In spite of these poor results, companies that market consumer packaged goods (CPG) spend billions of dollars annually to produce, distribute, and monitor their promotional displays to increase sales.

It would be advantageous to have an automated, real-time tracking system for in-store promotional sales of given products. In such a system, displays that function the best may be determined in real-time and, if necessary, augmented. Displays that are not functioning well can be removed. Such a system may automatically cover stores in a chain to determine if the proper number of in-store displays (e.g., freestanding floor displays, sidewing displays, countertop unit displays, PDQ tray displays, pallet module displays, sign and standee displays, permanent displays, semi-permanent displays, or others) have been set up at predetermined stores within the chain, when they were set up, and the amount of sales of the promotional product occurring during the in-store promotion of the product. The term “display,” as used herein, is intended to cover shelves or product containers of all types, whether permanent or temporary, and may include displays, advertising or merchandising material containing products, products with other products associated with them, dump bins, racks, pegboards, counter-tops, dispensers, or other materials intended to hold consumer products in a retail facility and desired to be monitored for presence/absence by retailers or manufacturers. Stores or retail establishments that could be covered by the system include any retail environment.

The following commonly-owned U.S. patents and application are related to the systems and methods described herein: U.S. Pat. No. 6,837,427, granted Jan. 4, 2005; U.S. Pat. No. 6,951,305, issued Oct. 4, 2005; U.S. patent application Ser. No. 10/665,540, filed Sep. 18, 2003; U.S. Pat. No. 7,021,535, issued Apr. 4, 2006; U.S. Provisional Application No. 60/625,273, filed Nov. 5, 2004; U.S. Provisional Application No. 60/629,496, filed Nov. 19, 2004; and U.S. Provisional Application No. 60/629,216, filed Nov. 18, 2004.

### SUMMARY

In accordance with the teachings described herein, systems and methods are provided for measuring the effectiveness of an advertising display. A radio frequency identification (RFID) tag may be associated with an advertising display in a retail environment. One or more receivers may be used to receive an RFID signal from the RFID tag. One or more processors may be used to receive the RFID signal from the receivers to determine a time period during which the display is located within the retail environment. The one or more processors may also receive sales data from the retail environment relating to an amount of sales of one or more products associated with the advertising display over the time period that the advertising display is located within the retail environment. At least one processor compares the sales data with one or more sets of other data to measure the effectiveness of the advertising display.

An example method for measuring the effectiveness of an advertising display in a retail environment may include the steps of: electronically monitoring the advertising display to determine a time period during which the advertising display is located within the retail environment; receiving sales data from the retail environment relating to an amount of sales of one or more products associated with the advertising display over the time period that the advertising display is located within the retail environment; and comparing the sales data with one or more sets of control data to measure the effectiveness of the advertising display.

In one embodiment, a system and method is provided for determining the effectiveness and profitability of in-store product advertising programs that utilize displays, and, in particular, for determining average sales and profits for a given product that has been sold as a result of an in-store product display advertisement program in a given facility or group of facilities when compared to the same product sold by the same facility or group of facilities without an in-store product display advertisement. The system or method may compare product sales for stores with the promotional displays as opposed to those without the displays. The product advertising program can be tracked over a given time period (e.g., a day) for each store and for each display location within a given store. If a product sells well in one geographical area but not in another, the displays in the geographical area where the sales are poor can be dismantled and the promotional sales can be discontinued in real time.

In certain embodiments, the systems and methods described herein may increase sales of the products involved in an in-store product display promotion because promotional execution is improved, out-of-compliance promotional displays can be remediated during the promotion, displays or displays in particular locations that create the highest sales lift are identified in real-time and enable strategic sales insights to be gained, fast selling display packs can be re-ordered during the promotion, unique display assortments and locations can be suggested by store, and better conditions for display execution and advertising can be obtained.

With better data, better planning is achieved. In certain embodiments, the systems and methods described herein may be used to collect execution data from designated stores on a daily, accurate, and immediate basis. Sales data in the designated stores may be collected and the sales data and the execution data may be combined to provide the necessary information to increase the sales of the promoted product.

In certain embodiments, each in-store promotional display may have an associated RFID tag that contains unique information regarding the product being promoted, such as its UPC. The RFID tag may be an electronic “chip” that is applied (or attached) to the in-store promotional displays for the product being promoted. Such tags may range in size from a postage stamp to a thick credit card and can be of various types, such as disclosed in commonly-owned U.S. patent application Ser. No. 10/665,540. The tags can be passive tags that respond only when interrogated, or active tags that transmit RF data on a periodic basis to conserve power. It should be understood, however, that various techniques may be utilized for transmitting data from the RFID tag to achieve the operational functions described herein.

In certain embodiments, the RFID tags may identify themselves, the display to which they are attached, and the presence or absence of the display in its pre-determined location. RFID sensors or readers may be used to electronically detect the contents of RFID tags within a certain range. The presence or absence of a signal, coupled with a time basis, may provide information regarding the time at which the display was erected, set up, or placed for the product promotion (within the range of the reader). The RFID sensors may be configured to read, at present, data from all RFID tags, for example within a 90 foot range. Each store may have many readers, each monitoring a key area, such as cosmetics, pharmacy, paper products, and/or other areas. The reader could receive data from a temporary display, a permanent display, a seasonal display, a promotional display, and/or any other type of display. The reader may also be configured to determine if the display is properly located.

In one embodiment, a method is provided for prioritization of the effectiveness and profitability of in-store displays that includes the steps of: automatically and electronically determining the presence or absence of at least one in-store product display for at least one corresponding product within at least one given store during a given time period; accumulating the amount of sales of the at least one product advertised with the presence of the at least one corresponding product display advertisement over the given time period; and determining sales of the at least one product occurring without the presence of the at least one in-store product display to evaluate the effectiveness of the particular product in-store advertising display.

In another embodiment, a method is provided that includes the steps of: comparing sales of the at least one product occurring during the presence of the corresponding at least one in-store product display with sales of the at least one product occurring without the presence of the at least one in-store product display; and calculating the average sales/profits for the at least one product sold without the presence of the in-store product display advertisement over the given time period and the average sales/profit for the product sold with the presence of the corresponding in-store product display advertisement over the given time period to determine the effectiveness of the in-store promotional display.

### BRIEF DESCRIPTION OF THE DRAWINGS

FIG. 1 depicts an example in-store product promotion display.

FIG. 2 depicts an example communication system for monitoring a plurality of product displays within a retail environment.

FIGS. 3A and 3B are flow charts depicting an example method for measuring the effectiveness of in-store display advertising.

FIGS. 4-8 depict several example reports that may be generated using the systems and methods described herein.

### DETAILED DESCRIPTION

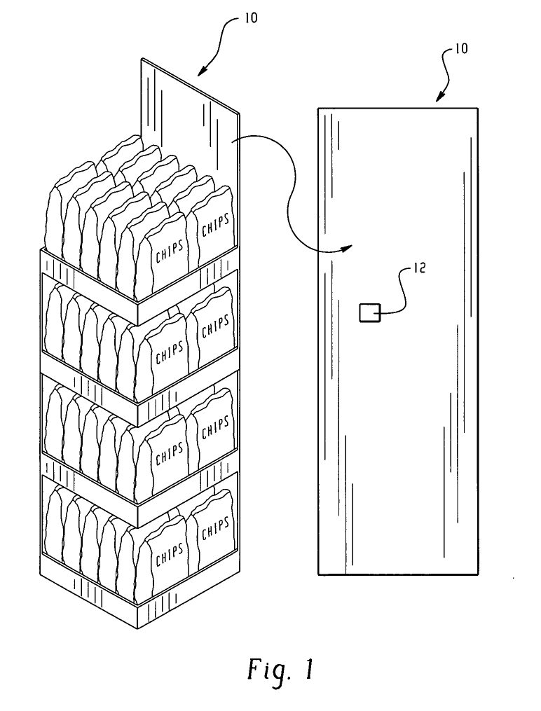

FIG. 1 depicts an example in-store product promotion display. The left-most portion of FIG. 1 depicts a front perspective view of the display, and the right-most portion of FIG. 1 depicts a rear view of the display. As illustrated, an RFID tag 12 may be attached to the display 10, preferably in an inconspicuous location such as the back of the display. The RFID tag 12 typically stores an identification number, which may be used by an RFID system to determine product information, such as the product type or category (e.g., food, pharmacy, candy, etc.), product promotion ID, and/or other product information. It should be understood that the display 10 may be a free standing display as illustrated, but could also be other types of product displays or containers.

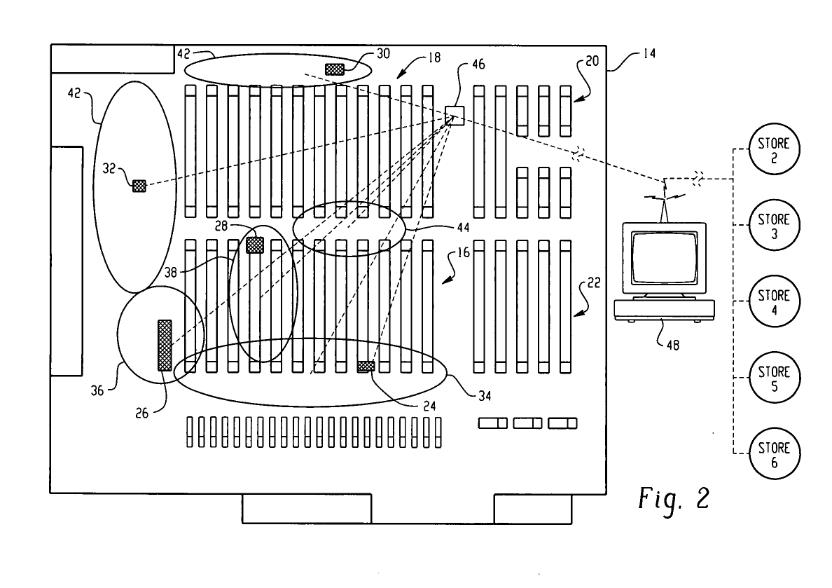

FIG. 2 depicts an example communication system for monitoring a plurality of product displays 24, 26, 28, 30 and 32 within a retail environment 14. The retail environment 14 has a plurality of shelving areas 16, 18, 20, and 22 where products may be stocked. A plurality of promotional displays 24, 26, 28, 30 and 32 are located at various positions or locations within the retail environment. Each display may, for example, be used to advertise a particular product. Different types of displays may be used, such as temporary displays, permanent displays, seasonal displays, promotional shipping containers, or others.

Each display in the retail environment 14 has an associated RFID tag 12, which transmits data to one or more RFID tag readers. Various types of active or passive RFID tags may be used, including the RFID tags described in commonly-owned U.S. Pat. Nos. 6,837,4426, and 7,021,535, which are incorporated herein by reference in their entirety.

One advantage of both a passive reader and a passive tag is that they require no batteries that need to be replaced or recharged. Such readers and tags are known in the art, and are therefore not described herein.

The communication system may include an RFID tag reader for each of a plurality of reader zones 34, 36, 38, 40, 42, 44 within the retail environment. In FIG. 2, a plurality of example reader zones 34, 36, 38, 40, 42, 44 are each represented by an ellipse, such that the RFID tag reader associated with each zone can read all RFID tags located within the area of the ellipse. For example, the reader in the zone represented by ellipse 34 can read the data from the RFID tag attached to display 24, as well as any other RFID tags in the zone. Similarly, the reader in the zone represented by ellipse 36 can receive data from all RFID tags located within the ellipse 36, including display 26. All of the other readers in the zones represented by ellipses 38, 40, 42, and 44 receive data from the RFID tags within their respective zones. An advantageous system of readers is described in copending PCT Application No. PCT/US05/37138, filed Oct. 18, 2005, the entirety of which is incorporated herein by reference.

In addition to monitoring the presence of an RFID tag within a zone, the RFID readers may also be configured to determine the location of an RFID tag within a zone. In this manner, the communication system may be able to determine whether the display is placed in the proper location for the promotion.

The RFID tag readers for each zone 34, 36, 38, 40, 42, 44 may transmit data received from the RFID tags to a central HUB station 46. The data received by the HUB station 46 may, for example, include tag identification data (e.g., tag numbers), store identification data, time and/or date information (e.g., a time stamp), and/or other information received from the RFID tags or generated by the RFID tag readers. In addition, the HUB 46 may transmit its received data to a centralized computer 48 that also receives data from other retail environments (stores 2-6). In this manner, comparisons may be made with data from other stores in a chain. The store HUBS 46 may, for example, automatically report tag changes to the centralized computer to update advertising campaign information. In addition, either the HUB station 46 or the centralized computer 48 may use the data received from the RFID readers to determine additional information relevant to the advertising campaign, such as product category (e.g., medicine, bread, juice, clothing, etc.), advertising information (e.g., when was the display is scheduled to be put up and taken down, etc.), product UPC code, product promotion ID, or other information.

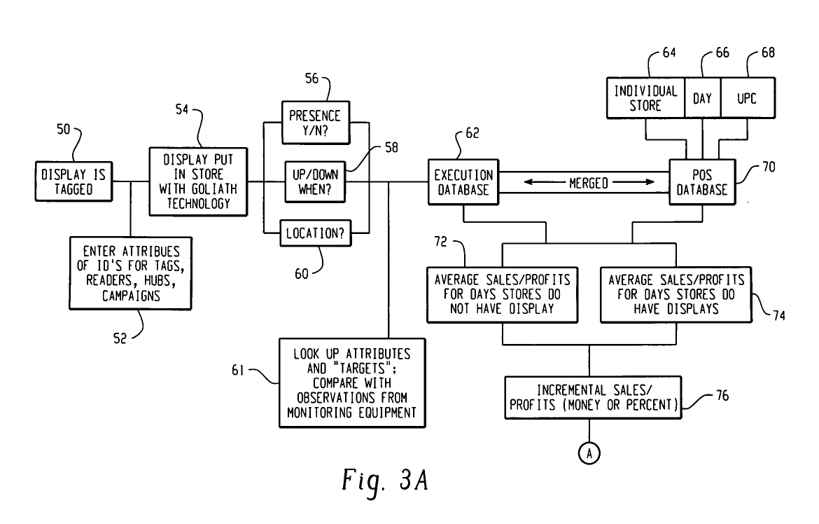

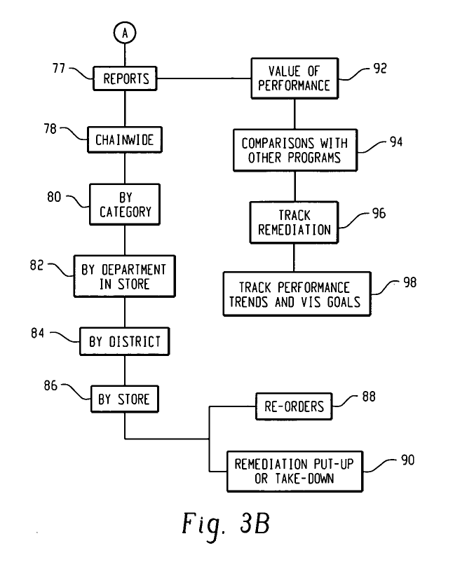

FIGS. 3A and 3B are flow charts depicting an example method for measuring the effectiveness of in-store display advertising. With reference to FIG. 3A, RFID tags are affixed to or otherwise associated with promotional in-store displays at step 50. At step 52, data is entered into a central computer, for example to associate the RFID tags and other components of the RFID system with information relating to the promotional displays. For example, the data entered into the central computer may include identification numbers for the RFID tags, readers, HUBS, stores, campaigns, and the like. In addition, other relevant data may be entered into the central computer, such as fixed administrative data and advertising promotion data. This information may, for example, enable the centralized computer to identify the location of a received signal and to associate the received signal with the appropriate promotional display.

The promotional display is placed in a retail environment at step 54, and the RFID signal from the associated tag is received and processed by the RFID system at steps 56, 58 and 60. When an RFID signal is detected by an RFID tag reader, the presence of the RFID tag within the retail environment is indicated at step 56. Also, the time and/or date that the signal is received is recorded at step 58, for example to verify that the display has been placed in the retail environment according to the provisions of an advertising agreement. The location of the display within the retail environment may also be determined and recorded at step 60, for example to verify that the display has been placed at the agreed upon location within the retail environment or that the display is properly located with reference to the product being promoted. The data from steps 56, 58 and 60, along with other relevant data (step 61), may be stored in a centralized execution database, as depicted in step 62. The execution database may, for example, be controlled by the centralized computer. The data stored in the execution database may, for example, include information sufficient to determine that the product promotional display campaign has begun, that the in-store displays are properly positioned or located within the store, that the promotional campaign has been identified, the product identified, the store identified, the RFID tags identified, the readers identified, the HUBS identified, and/or other relevant information.

Also depicted in FIG. 3A is point-of-sale data 64, 66, 68 relating to one or more of the products associated with the promotional display that is received by a POS database 70. The POS database 70 may, for example, receive sales data from a plurality of retail environments involved in the promotion, as illustrated by step 64. The POS data received by the POS database 70 may also include data indicating the time and/or date of the sale (step 66) and the UPC identifier for the products sold (step 68).

data from the execution database (step 62) and the POS database (step 70) is merged, for example by a centralized computer, to determine the effectiveness and/or profitability of the in-store display. The effectiveness and/or profitability may be determined by using the merged data to compare sales data over a time period during which the display is located in the retail environment with one or more sets of other or control data. For example, the merged data may be used to compare the average sales/profits for days when the display is not in the retail environment (step 74) with the average sales/profits for days when the display is in the retail environment (step 72). From this comparison, the system may determine the incremental sales and/or profits resulting from the presence of the in-store product promotion displays, as depicted at step 76.

With reference to FIG. 3B, the information obtained from the merged RFID and POS data may be used to generate one or more reports, as depicted at step 77. As illustrated, the reports may be generated over a broad range of categories (e.g., steps 78, 80, 82, 84, 86) and may include various types of information relating to the effectiveness and/or profitability of the in-store display (e.g., steps 88, 90, 92, 94, 96, 98). For example, reports may be generated by retail chain (step 78), by product category (step 80), by in-store department (step 82), by district or geographical area (step 84), by store (step 86), and/or according to other categories. The report data may, for example, be used to determine whether additional promotional in-store displays should be re-ordered (step 88), or whether displays should be removed from locations where sales are poor and/or whether additional displays should be added at locations with improved sales (step 90). The reports may, for example, be generated on a daily basis or at some other predetermined time interval. The reports may, for example, include compliance data, such as whether the in-store display was up and in the targeted location.

It should be understood that one or more of the steps and the order in the flowchart may be altered, deleted, modified and/or augmented and still achieve the desired outcome.

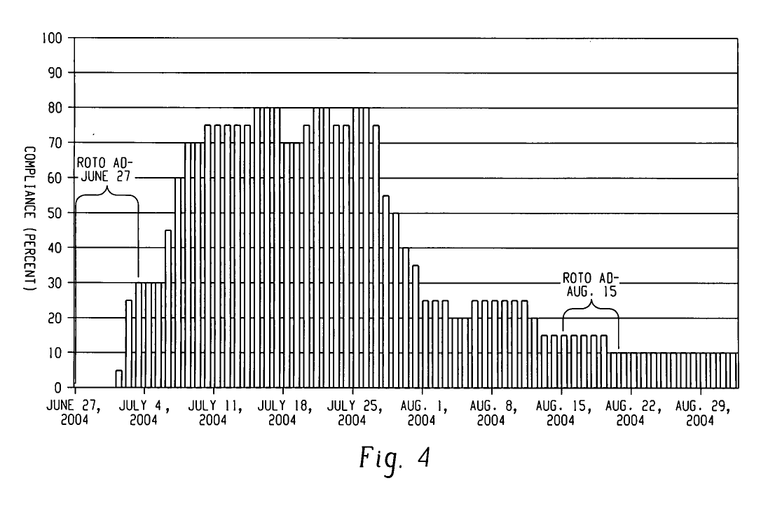

FIGS. 4-8 depict several example reports that may be generated using the systems and methods described herein. FIG. 4 is a report illustrating compliance by day for a summer seasonal display within a retail environment. This example report shows that the days having the highest compliance percentage did not correspond with the days (June 27 and August 15) during which a related promotional advertisement was run.

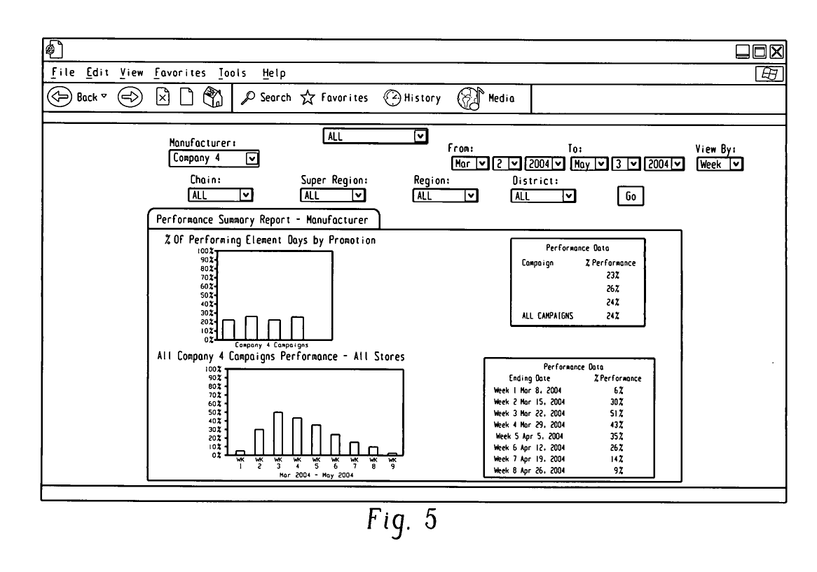

FIG. 5 depicts an example graphical user interface (GUI) for generating a performance summary. The GUI may, for example, be generated by the centralized computer 48 shown in FIG. 2. In one example, the GUI may be accessible over a computer network, such as the Internet. The GUI includes user input fields to define the report generation criteria. For example, the report may be generated for a particular manufacturer covering stores in designated regions and districts for a campaign over a selected time period. The user input regions may also include searchable fields, such as category, brand, promotion, agency, location zone, channel of trade, retailer chain, store, geography, unit/territory, or other relevant search criteria.

The performance summary report for a selected manufacturer is shown in FIG. 5 by a bar graph that indicates a percentage of element days by promotion. In addition, the user may select performance data for each specific advertising campaign or for all advertising campaigns, as shown. In the illustrated example, performance data for each week of four campaigns is shown, along with performance data for each week of the campaign.

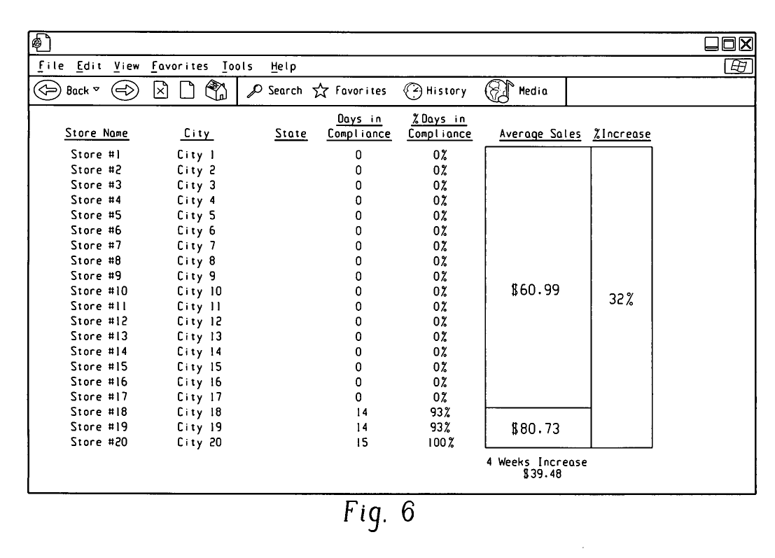

FIG. 6 depicts another example report showing compliance results relating to an in-store display for a sales campaign for product Brand X. In the illustrated example, average sales are compared between stores that are in compliance with the advertising agreement and stores that are not in compliance.

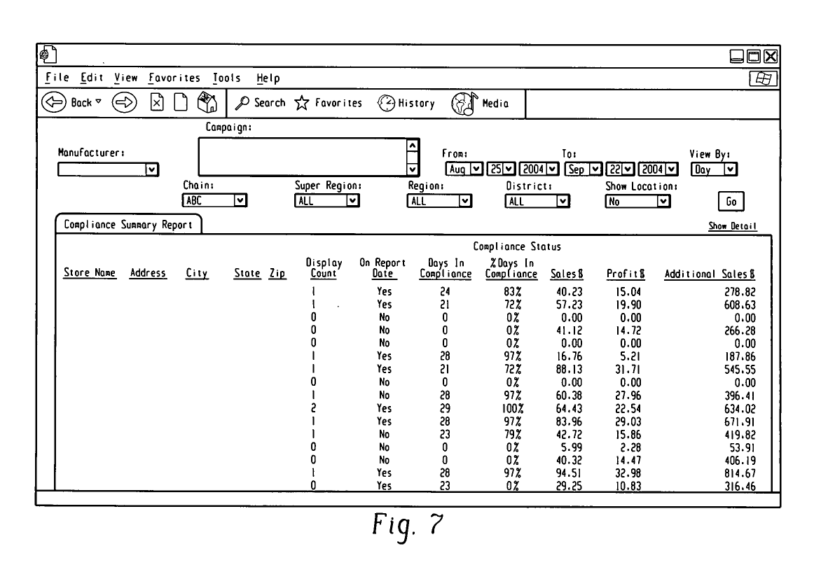

FIG. 7 depicts another example GUI for generating a compliance summary report. In this example, a report is generated that shows the results of a promotion across a plurality of stores. The sales and profits for each of the stores (both in and out of compliance) is shown and can be compared.

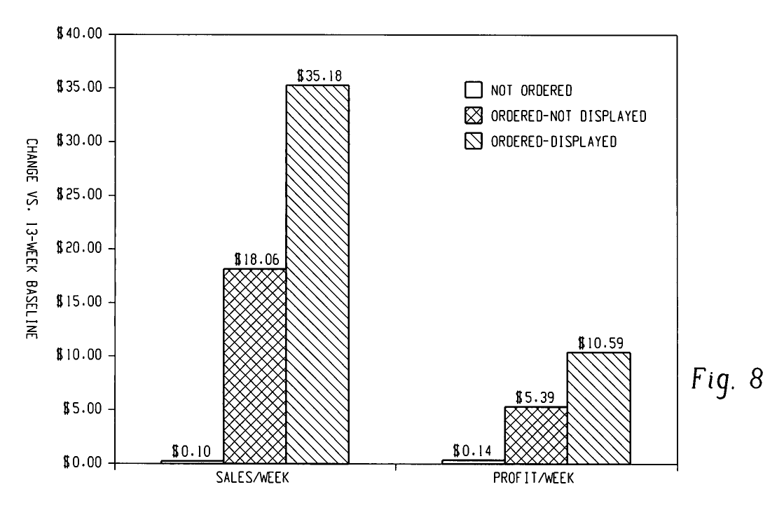

FIG. 8 depicts an example report showing sales and profits per week. This example report compares sales and profits for a product when the display is not ordered, when the display is ordered but not displayed in compliance, and when the display is ordered and displayed in compliance.

The systems and method disclosed herein may, for example, be used to integrate in-store promotional display execution data with store POS data to provide promotional performance insights. Certain embodiments of such systems and methods may include, at a first level, collecting and storing data regarding display information and compliance with an advertising program, and collecting point of sale data regarding products relating to the program and merging the data in a meaningful manner.

In certain embodiments, the systems and methods disclosed herein may, at a second level, generate weekly reports of sales and compliance, including sales at unit and dollar levels, aggregated by geography and using data feed from retailers for sales; creating a sales results database by populating a sales results database with daily results by store by UPC, and maintaining daily data to roll-up into set periods, e.g., weekly, monthly, quarterly, and annually.

In certain embodiments, the systems and methods disclosed herein may, at a third level, generate monthly reports of samples, sales trends, and compliance. Sales data may include the prior 12 months historical sales, and sales at the brand and category level. The monthly report may include the promotion trend according to item and brand detail with weekly trends and comparisons to the prior year made available. The report may be aggregated by geography with a summary of data at a particular location and store. To collect enhanced sales data, the following steps may be used: first, identify a sales data source with a retail partner; second, use hierarchical rules from UPC up to brand and category; third, communicate required UPC data and associated hierarchy; and fourth, extract data for required UPCs and hierarchy including sales dollars and units, prior year, same time period, and monthly by store. The data may be transmitted according to an ongoing schedule.

In certain embodiments, the databases developed for levels 1, 2 and 3, may include a program compliance database, a sales results database, and an enhanced sales results database (which may be the same as the results database). Definition databases may include the central computer network location, retail store location definitions (store and in-store locations), the promotion program element, the RFID chip matched to the promotion program, geographic aggregations for the retailer and manufacturer, and the product, brand and category.

In certain embodiments for a web based reporting system, searchable data fields may include category, brand, promotion, agency, location zone, channel of trade, retailer chain, store, geography, unit/territory, out of compliance only, elapsed time “out of compliance,” DSD or warehouse, time period, fixture type, and sales region or representative.

Embodiments of the systems and methods disclosed herein may be used for integration of display execution data with store POS data to provide real time performance data of product in-store promotional displays. The retailer, at level 1, can use the data as a daily tracking system on key programs to ensure individual store compliance with the local plan. It can also be used by the retailer at headquarters as a tool to ensure local execution targets are achieved and to establish new store target expansion. Manufacturers, at level 1, can use the data to identify stores that require work to achieve desired targets and also give headquarters an understanding of where to deploy resources.

In certain embodiments, the retailer, at level 2, can use the data to obtain a weekly understanding of sales impact from promotions. Local managers can use the data as a fact based tool to guide their decisions. Retailers can also use level 2 data for a weekly evaluation of programs created with vendors. Manufacturers can use the level 2 data to obtain an early evaluation of performance activity and spending and to determine areas in which to work with retailers to address shortfalls in sales results.

In certain embodiments, retailers may use level 3 data to improve individual store operations by linking category growth with a documented understanding of promotion activity. Retailers can also use the level 3 data in category management by understanding the vehicles that drive category growth under different conditions and gives retailers the opportunity to work with vendors to optimize programs and vendor support. Manufacturers can use the level 3 data to link sales with promotion activity and provide a platform for determining where to spend promotion dollars. At the manufacturer's headquarters, the level 3 data can be used to obtain a better understanding of investment and ROI (return on investment) in order to improve strategic decisions on where to invest to grow the brand.

This written description uses examples to disclose the invention, including the best mode, and also to enable a person skilled in the art to make and use the invention. The patentable scope of the invention may include other examples that occur to those skilled in the art.

It is further noted that the systems and methods described herein may be implemented on various types of computer architectures, such as for example on a single general purpose computer or workstation, or on a networked system, or in a client-server configuration, or in an application service provider configuration.

It is further noted that the systems and methods may include data signals conveyed via networks (e.g., local area network, wide area network, internet, etc.), fiber optic medium, carrier waves, wireless networks, etc. for communication with one or more data processing devices. The data signals can carry any or all of the data disclosed herein that is provided to or from a device.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The systems' and methods' data (e.g., associations, mappings, etc.) may be stored and implemented in one or more different types of computer-implemented ways, such as different types of storage devices and programming constructs (e.g., data stores, RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

It is claimed:

1. A system for measuring the effectiveness of an advertising display in a retail environment, comprising:
a radio frequency identification (RFID) tag associated with the advertising display;
one or more receivers that receive an RFID signal from the RFID tag; and
one or more processors that receive the RFID signal from the receivers to determine a time period during which the advertising display is located within the retail environment;
the one or more processors receiving sales data from the retail environment relating to an amount of sales of one or more products associated with the advertising display over the time period that the advertising display is to be located within the retail environment;
the one or more processors comparing the sales data with one or more sets of related data to measure the effectiveness of the advertising display.

2. The system of claim 1, wherein the one or more sets of related data include sales data from the retail environment over a second time period during which the advertising display is not located within the retail environment.

3. The system of claim 1, wherein the one or more processors use the RFID signal to determine that the advertising display is at a predetermined location within the retail environment during the time period.

4. The system of claim 1, wherein the one or more processors include a hub station coupled to a plurality of RFID tag readers.

5. The system of claim 4, wherein the hub station further receives a plurality of additional RFID signals from a plurality of additional RFID tags, each RFID tag being associated with an additional advertising display.

6. The system of claim 5, wherein the RFID signal and the plurality of additional RFID signals are used to measure the effectiveness of the advertising display.

7. The system of claim 4, wherein the one or more processors include a central computer coupled to the hub station.

8. The system of claim 5, wherein the central computer is also coupled to hub stations in one or more additional retail environments.

9. The system of claim 6, wherein RFID signals from a plurality of advertising displays in a plurality of retail environments are used to measure the effectiveness of the advertising display.

10. The system of claim 1, wherein:
the one or more processors calculate a first average profit value for the sales of the one or more products over the time period that the advertising display is located within the retail environment; and
the one or more processors calculate a second average profit value for the sales of the one or more products over the second time period during which the advertising display is not located within the retail environment;
wherein the first average profit value and the second average profit value are compared to measure a profitability of the advertising display.

11. A computer-implemented method of measuring the effectiveness of an advertising display in a retail environment, comprising:
electronically monitoring the advertising display to determine a time period during which the advertising display is located within the retail environment;
receiving sales data from the retail environment relating to an amount of sales of one or more products associated with the advertising display over the time period that the advertising display is located within the retail environment; and
comparing the sales data with one or more sets of control data to measure the effectiveness of the advertising display.

12. The method of claim 11, wherein the one or more sets of control data include sales data from the retail environment over a second time period during which the advertising display is not located within the retail environment.

13. The method of claim 12, further comprising:
calculating a first average profit value for the sales of the one or more products over the time period that the advertising display is located within the retail environment; and
calculating a second average profit value for the sales of the one or more products over the second time period during which the advertising display is not located within the retail environment;
wherein the first average profit value and the second average profit value are compared to measure a profitability of the advertising display.

14. The method of claim 11, further comprising:
electronically monitoring the advertising display to determine that the advertising display is at a predetermined location within the retail environment during the time period.

15. The method of claim 11, wherein a radio frequency identification (RFID) system is used to electronically monitor the advertising display.

16. The method of claim 15, wherein an RFID tag is associated with the advertising display and is used to electronically monitor the advertising display in the RFID system.

17. A system for measuring the effectiveness of an advertising display in a retail environment, comprising:
a radio frequency identification (RFID) tag associated with the advertising display;
means for receiving an RFID signal from the RFID tag to determine a time period during which the advertising display is located within the retail environment;
means for receiving sales data from the retail environment relating to an amount of sales of one or more products associated with the advertising display over the time period that the advertising display is located within the retail environment; and
means for comparing the sales data with one or more sets of control data to measure the effectiveness of the advertising display.

18. A method for prioritization of the effectiveness and profitability of in-store display advertising comprising the steps of:
automatically and electronically determining the presence or absence of at least one in-store product display advertisement for least one corresponding product within at least one given store during a given time period;
determining the amount of sales of the at least one product advertised with the presence of the at least one corresponding product display advertisement over the given time period;
comparing sales of the at least one product occurring during the presence of the corresponding at least one in-store product display with sales of the at least one product occurring without the presence of the at least one in-store corresponding product display; and
calculating the average sales/profits for the at least one product sold without the presence of the in-store product display advertisement over the given time period and the average sales/profits for the product sold with the presence of the corresponding in-store product display advertisement over the given time period.

19. The method of claim 18 further including the step of determining the presence or absence of the at least one corresponding in-store product display advertisement in a specified location in the at least one given store.

20. The method of claim 18 further including the step of determining the incremental sales/profits resulting from the presence of in-store product display advertisements.

21. The method of claim 18 further comprising the steps of:
attaching an RFID tag to the corresponding in-store product display advertisement for transmitting identification information; and
receiving the transmitted identification information with an in-store HUB processor that has stored attributes relating to the tag for identification of the corresponding in-store product display advertisement and its location.

22. The method of claim 18 further comprising the steps of:
associating a UPC code with each product advertised by the corresponding in-store product display advertisements;
storing the UPC codes in a central computer; and
receiving point of sale data, including the UPC code, for comparison with the stored UPC codes in order to monitor sales of the at least one advertised product.

23. A method for determining the effectiveness and profitability of in-store product display advertising comprising the steps of:
automatically and electronically monitoring the sale of a product in a retail establishment both in and without the presence of an in-store product display advertising; and
automatically comparing the sales of the product in the presence of the in-store product advertising display with the sales of the same product without the presence of the in-store display advertising to determine, on a real-time basis, the effectiveness of the in-store product display advertising on the sales of the product.

24. A system for determining the effectiveness and profitability of in-store product display advertising comprising:
a central computer for receiving and storing data related to the in-store product display such that the presence or absence of the in-store product display is determined and the product being advertised by the in-store product display is identified; and
an in-store point-of-sale (POS) electronic signal transmitter transferring all sales data regarding sales of the product in the presence of the in-store product display and all sales data regarding the product sold without the presence of the in-store product display to the central computer for comparison such that the effectiveness and profitability of product sales with the use of in-store product display advertising is determined.

25. The system of claim 24 further including:
an RFID tag associated with the in-store product display, each RFID tag including at least data identifying itself and the product associated with the product display;
an RF signal reader associated with the RFID tag for generating product display execution data by periodically receiving the RFID tag data and generating data that determines if the in-store display is present and, if so, its location within the store; and
an in-store display data transmitter for receiving the RF signal reader execution data and transmitting the execution data to the central computer to enable the central computer to merge the execution data with the POS data to determine the effectiveness and profitability of an in-place, in-store product advertising display.

26. The system of claim 24, wherein the central computer is configured to generate a report that shows compliance results relating to an advertising agreement concerning the in-store product display.

27. The system of claim 26, wherein the report compares average sales between one or more stores that are in compliance with the advertising agreement and one or more stores that are not in compliance with the advertising agreement.

28. The system of claim 24, wherein the central computer is configured to generate a report that shows results of a promotion across a plurality of stores related to the in-store product display.

29. The system of claim 28, wherein the report compares sales and profitability between the plurality of stores.

30. The system of claim 24, wherein the central computer is configured to generate a report that shows sales and profits of the product on a per week basis.

31. The system of claim 30, wherein the report compares sales and profits for the product when the in-store display is present and in compliance with an advertising agreement relating to the in-store display with sales and profits for the product when the in-store display is not present and in compliance with the advertising agreement.

32. The system of claim 24, wherein the central computer is configured to generate a report that shows sales at unit and dollar levels aggregated by geography.

33. The system of claim 24, wherein the central computer is configured to generate a report that shows sales and profits of the product on a per month basis.

34. The system of claim 24, wherein the central computer is accessible via a computer network, further comprising:
user interface software for searching the data stored in the central computer via the computer network.

35. The system of claim 34, wherein the stored data may be searched using one or more searchable data fields.

36. The system of claim 35, wherein the searchable data fields include one or more of a category field, a brand field, a promotion field, an agency field, a location zone field, a channel of trade field, a retailer chain field, a store field, a geography field, a unit field, a territory field, an out of compliance field, an elapsed time out of compliance field, a warehouse field, a time period field, a fixture type field, a sales region field, and a representative field.
